(19) United States
(12) Patent Application Publication
(10) Pub. No.: US 2008/0024049 A1
(43) Pub. Date: Jan. 31, 2008

(54) Plasma tube array

(75) Inventors: Hitoshi Hirakawa, Kobe (JP); Manabu Ishimoto, Kobe (JP); Kenji Awamoto, Kobe (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CORPORATION, Kobe (JP)

(21) Appl. No.: 11/905,138

(22) Filed: Sep. 27, 2007

Related U.S. Application Data
(63) Continuation of application No. PCT/JP05/06093, filed on Mar. 30, 2005.

(51) Int. Cl. H01J 63/04; H01J 1/62

(52) U.S. Cl. 313/485

(57) ABSTRACT

A plasma tube array includes a front supporting substrate, a back supporting substrate, display electrode pairs and signal electrodes, and wirings. The front supporting substrate and the back supporting substrate overlap each other, with a discharge space formed therebetween. The display electrode pairs are formed on the inner surface of the front supporting substrate. The signal electrodes are formed on the back substrate. The plasma tube array displays an image by allowing light to be emitted by applying a voltage to the signal electrodes and the display electrode pairs. The wirings are formed on an outer surface of the front supporting substrate so as to correspond respectively to the display electrodes. The wirings extend parallel to the display electrodes, and are connected to the corresponding display electrodes, respectively.

### TECHNICAL FIELD

The present invention relates to a plasma tube array, in which arc tubes each having a phosphor layer inside are arranged, and which displays an image by causing discharge inside the arc tubes, and thereby allowing the phosphor layers inside the arc tubes to emit light.

### BACKGROUND ART

As a large self-luminous image display device, a technique has been proposed, which applies the principle of a plasma display. Specifically, a number of luminous yarns are arranged. Each luminous yarn is formed of a glass tube which has a phosphor layer and the like inside, and which is used for displaying an image by controlling light emission in each portion of each luminous yarn (see Patent Document 1).

In each of the luminous yarns, an MgO layer and the phosphor layer are formed inside the glass tube, and discharge gas made of, for example, Ne and Xe is enclosed in the glass tube. The phosphor layer is formed on a supporting member called a boat, which is a mounting component having a substantially semicircular cross-sectional shape. The supporting member (boat) is then inserted into the glass tube. Thereafter, the glass tube is heated and evacuated in a vacuum chamber. After the glass tube is filled with the discharge gas, both ends of the glass tube are melted to be sealed. The luminous yarns each fabricated in this manner are arranged in parallel and fixed, and also electrodes are provided above and below the luminous yarns, respectively. Subsequently, a voltage is applied to the electrodes so as to cause discharge inside the luminous yarns. Thereby, the phosphor emits light.

FIG. 1 is a perspective view showing a basic structure of a plasma tube array.

A plasma tube array 100 shown in FIG. 1 has the following structure. Specifically, a large number of luminous yarns 10R, 10G, 10B, 10R, 10G, 10B, . . . are arranged in parallel with one another, and in a planar shape as a whole. In each luminous yarn, a phosphor layer is disposed, and discharge gas is enclosed. Each of the phosphor layers 10R, 10G, 10B, 10R, 10G, 10B, . . . , emits fluorescence of a corresponding one of red (R), green (G) and blue (B). On front and back sides of the luminous yarns 10R, 10G, 10B, 10R, 10G, 10B, . . . thus arranged, transparent front and back supporting substrates 20 and 30 are disposed, respectively. The arranged luminous yarns 10R, 10G, 10B, 10R, 10G, 10B, . . . , have a structure in which the luminous yarns are sandwiched between the front and back supporting substrates 20 and 30.

Moreover, on the front supporting substrate 20, display electrode pairs 21 are formed in a direction in which the luminous yarns 10R, 10G, 10B, 10R, 10G, 10B, . . . , are arranged. In other words, the display electrode pairs 21 are formed across the luminous yarns 10R, 10G, 10B, 10R, 10G, 10B, . . . . Each electrode pair 21 includes two display electrodes 211 and 212 extending parallel to each other. A number of the display electrode pairs 21 are arranged in the longitudinal direction of the luminous yarns 10R, 10G, 10B, 10R, 10G, 10B, . . . . Moreover, each two display electrodes 211 and 212 included in each display electrode pair 21 are formed of bus electrodes 211a and 212a, and transparent electrodes 211b and 212b. The bus electrodes 211a and 212a are made of metal (for example, Cr/Cu/Cr), and are formed respectively at sides far away from each other. In addition, the transparent electrodes 211b and 212b are formed of ITO thin films, and are formed respectively at sides adjacent to each other. The bus electrodes 211a and 212a are used for reducing electric resistance of the corresponding display electrodes 211 and 212, and the transparent electrodes 211b and 212b are designed to achieve bright display by transmitting light emitted by the luminous yarns 10R, 10G, 10B, 10R, 10G, 10B, . . . towards the front supporting substrate 20 without shielding the light. Here, each of the display electrode pairs 21 may be formed of an electrode having a structure with a high aperture ratio, such as a mesh electrode, instead of the transparent electrode.

Moreover, on the back supporting substrate 30, a number of signal electrodes 31 are formed so as to correspond to the arranged luminous yarns 10R, 10G, 10B, 10R, 10G, 10B, . . . . The signal electrodes 31 are made of metal, and extend parallel to each other along the respective luminous yarns.

When the PTA 100 configured in this manner is viewed from directly above, each of the intersections of the signal electrodes 31 and the display electrode pairs 21 serves as a unit light emission region (a unit discharge region). Display is performed in the following manner. Specifically, one of the display electrodes 211 and 212 is used as a scanning electrode, and an emission region is selected by causing selective discharge in the intersection of the scanning electrode and the signal electrode 31. Wall charge is formed on the inner surface of the luminous yarn in the region in association with the discharge. Then, by utilizing the wall charge, display discharge is caused between the display electrodes 211 and 212, and thereby display is performed. The selective discharge is counter discharge caused inside the luminous yarn between the scanning electrode and the signal electrode 31 which face each other in the up-and-down direction. Meanwhile, the display discharge is surface discharge caused inside the luminous yarn between the display electrodes 211 and 212 which are disposed in parallel on a plane. Such an arrangement of the electrodes allows formation of a number of light emission regions inside each of the luminous yarns in the longitudinal direction of the luminous yarns.

Here, in the electrode structure shown in FIG. 1, three electrodes are disposed in one light emission region, and the display discharge is caused by the display electrodes 211 and 212. However, the present invention is not limited to the structure, but may be applicable to a structure in which the display discharge is caused between the signal electrode 31 and the display electrodes 211 and 212. The present invention may be applicable to the following electrode structure. Specifically, each pair of the display electrodes 211 and 212 is replaced with one display electrode. By using this one display electrode as the scanning electrode, the selective discharge and the display discharge (counter discharge) are caused between the scanning electrode and a data electrode 3.

Moreover, for the front and back supporting substrates 20 and 30, glass substrates may be used, or substrates each made of a transparent polymeric material or the like may also be used.

FIG. 2 is a schematic view showing a structure of one pixel in the plasma tube array 100 shown in FIG. 1.

Here, FIG. 2 shows three luminous yarns 10R, 10G and 10B. Each of the luminous yarns 10R, 10G and 10B has the following structure. Specifically, a protective film 12 such as MgO is formed on the inner surface of a glass tube 11. Moreover, a boat 13 as a supporting member is inserted into each of the glass tube 11. In the boat 13, a corresponding one of phosphor layers 14R, 14G and 14B which emit fluorescence of the respective colors R, G and B, is formed (see Patent Document 2).

FIG. 3 is a view showing the boat in which the phosphor layer is formed.

The boat 13 has a semicircular or a substantially semicircular cross-sectional shape, and also has an elongated shape similar to the glass tube 11 (see FIG. 2). Inside the boat 13, a corresponding one of the three kinds of phosphor layers 14R, 14G and 14B (see FIG. 2: here, represented by the phosphor layer 14) is formed, The phosphor layers 14R, 14G and 14B correspond respectively to the three kinds of luminous yarns 10R, 10G and 10B shown in FIGS. 1 and 2.

The description will be continued with reference to FIG. 2 again.

Each of the luminous yarns 10R, 10G and 10B shown in FIG. 2 is formed by inserting the boat 13 having the shape shown in FIG. 3 into the glass tube 11. FIG. 2 shows that the display electrode pair 21 including two display electrodes 211 and 212 is disposed on the luminous yarns 10R, 10G and 10B. Each of the two display electrodes 211 and 212 is formed of the corresponding one of the bus electrodes 211a and 212a made of metal and the corresponding one of the transparent electrodes 211b and 212b, as described above.

Here, in the case of the structure shown in FIG. 2, the three luminous yarns 10R, 10G and 10B including the three kinds of phosphor layers 14R, 14G and 14B, respectively, are grouped into one set. Moreover, a region Dl defined by one display electrode pair 21 including two display electrodes 211 and 212 is set to be one pixel that is a unit of color image display. A diameter of each of the luminous yarns 10R, 10G and 10B is typically about 1 mm. In the case of the structure shown in FIG. 2, a size of the region Dl for one pixel is 3 mm×3 mm.

FIG. 4 is a view showing the front supporting substrate 20 and the display electrodes 211 and 212 formed on the front supporting substrate 20.

As shown in FIG. 4, on the inner surface of the front supporting substrate 20, the display electrode pair 21 is formed, which includes two display electrodes 211 and 212 extending parallel to each other so as to form a surface discharge gap G between the display electrodes 211 and 212. The display electrode pairs 21 are formed, and a reverse slit S for preventing discharge is formed between the display electrode pairs 21 adjacent to each other.

As to the two display electrodes 211 and 212 included in the display electrode pair 21, one side of each display electrode, which side is close to the surface discharge gap G, is formed of a corresponding one of the transparent electrodes 212b and 211b made of the ITO thin film. The other side thereof, which side is away from the surface discharge gap G (on the reverse slit S side), is formed of a corresponding one of the bus electrodes 211a and 212a. Here, as described above, the transparent electrodes 212b and 211b are provided for making it easy for light emitted by the phosphor layers within a discharge space corresponding to the surface discharge gap G to be transmitted through the glass substrates 11, and to be thereafter emitted to the front surface. Moreover, the bus electrodes 211a and 212a are provided for reducing resistance values of the respective display electrodes 211 and 212.

Here, when the width of each of the bus electrodes 211a and 212a is increased, the resistance value of each of the display electrodes 211 and 212 is reduced. From this perspective, it is preferable to increase the width. However, since the light emitted from the phosphor layers becomes more likely to be shielded, use efficiency of emitted light is lowered. This leads to a problem that it is difficult to obtain a bright display screen. Meanwhile, when the width of each of the bus electrodes 211a and 212a is reduced, the light emitted from the phosphor layers becomes less likely to be shielded. In this case, there is a problem that the resistance value of each of the display electrodes 211 and 212 is increased. In addition, the reverse slit S is a non-light-emission part, and reflectivity on the entire surface of a panel can be reduced by covering the non-light-emission part in black. This makes it possible to improve the bright room contrast. Thus, it is at least conceivable that the bus electrodes 211a and 212a are extended toward the reverse slit S. However, in this case, discharge may possibly occur in the reverse slit S. Consequently, it is impossible to extend the bus electrodes 211a and 212a.

Patent Document 1: Japanese Unexamined Patent Application Laid-open No. Sho 61-103187

Patent Document 2: Japanese Patent Application Laid-open No. 2003-86141

### DISCLOSURE OF THE INVENTION

### Problems to be Solved by the Invention

In consideration of the foregoing circumstances, an object of the present invention is to provide a display device which achieves a high-level balance between conflicting requests, for use efficiency of emitted light, and for a resistance value of a display electrode.

### Solution for Solving the Problem

Among plasma tube arrays of the present invention for achieving the foregoing object, a first plasma tube array is characterized by including: a number of arc tubes which are arranged parallel to one another, each arc tube including a phosphor layer inside; front and back supporting substrates which hold the arc tubes therebetween; a number of display electrodes which are formed in a direction across the arc tubes, on a surface of the front supporting substrate, the surface facing the arc tubes; a number of signal electrodes which are formed in a direction along the arc tubes in a manner that the signal electrodes correspond respectively to the arc tubes, on a surface of the back supporting substrate, the surface facing the arc tubes; and a number of wirings, which are formed in a direction in which the display electrodes are extended on a display surface of the front supporting substrate, the display surface being opposite to the surface where the display electrodes are formed, and which are connected respectively to the display electrodes.

Among the plasma tube arrays of the present invention, a second plasma tube array is characterized by including a number of unit panels each including: a number of arc tubes which are arranged parallel to one another, each arc tube including a phosphor layer inside; front and back supporting substrates which hold the arc tubes therebetween; a number of display electrodes which are formed in a direction across the arc tubes, on a surface of the front supporting substrate, the surface facing the arc tubes; a number of signal electrodes which are formed in a direction along the arc tubes so as to correspond respectively to the arc tubes, on a surface of the back supporting substrate, the surface facing the arc tubes; and a number of wirings, which are formed so as to correspond to the display electrodes on an outer surface of the front substrate, on the reverse side of an inner surface thereof where the display electrode pairs are arranged, which extend parallel to the display electrodes, and which are connected to the corresponding display electrodes. The plasma tube array is characterized in that each of the wirings is arranged in a direction linearly extending across the unit panels, and that the wirings are connected to each other between the unit panels adjacent to each other.

Here, in the plasma tube array of the present invention, at least a part of each of the display electrodes may be formed of an electrode made of an optically transparent material. Alternatively, at least a part of each of the display electrode may be formed of a mesh electrode made of a metal material.

Moreover, in the plasma tube array of the present invention, it is preferable that each of the display electrodes is connected to a corresponding one of the wirings at both ends of the front substrate by use of metal wires provided respectively across end faces of the front substrate.

Furthermore, in the plasma tube array of the present invention, it is preferable that the wirings are formed respectively at positions facing a reverse slit with a gap between the wirings, the gap being smaller than the width of the reverse slit.

### EFFECTS OF THE INVENTION

According to the present invention, the wirings are provided on the outer surface opposite to the inner surface where the display electrodes 211 and 212 are formed. The wirings replace or assist the bus electrodes 211a and 212a in the conventional example shown in FIG. 4. Accordingly, the resistance values of the display electrodes 211 and 212 are equivalently lowered. As a result, for example, the width of each of the bus electrodes 211a and 212a can be reduced, and light emitted by the phosphor layers can be utilized with high efficiency.

Moreover, the outer surface is exposed to the air. For this reason, discharge is unlikely to occur between the wirings even if the space between the wirings is very narrow. Accordingly, when each wiring is formed so as to cover a large part of the reverse slit S in the conventional example shown in FIG. 4, the reflectivity on the entire surface of the panel is reduced. As a result, it is also possible to improve the bright room contrast.

Furthermore, according to the present invention, it is also possible to standardize brightness or gradation expression among a number of base panels by connecting the wirings across the base panels.

### BRIEF DESCRIPTION OF THE DRAWINGS

FIG. 1 is a perspective view showing a basic structure of a plasma tube array.

FIG. 2 is a schematic view showing a structure for one pixel in the plasma tube array.

FIG. 3 is a view showing a board in which a phosphor layer is formed.

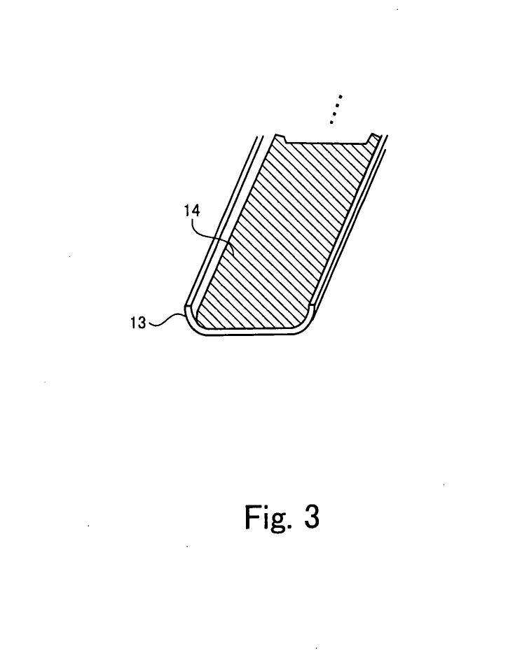

FIG. 4 is a view showing a front supporting substrate and display electrodes formed on the front supporting substrate.

FIG. 5 is a view showing a front supporting substrate and display electrodes formed on the front supporting substrate in a plasma display panel according to a first embodiment of the present invention.

FIG. 6 is a view showing a method of connecting the display electrodes formed on an inner surface of the front supporting substrate to wirings formed on an outer surface thereof according to the first embodiment shown in FIG. 5.

FIG. 7 is a view showing a front supporting substrate and display electrodes formed on the front supporting substrate in a plasma display panel according to a second embodiment of the present invention.

FIG. 8 is a view showing a method of connecting the display electrodes to wirings according to the second embodiment.

FIG. 9 is a plan view showing a connection state of a number of base panels obtained by implementing the present invention as described in the second embodiment shown in FIGS. 7 and 8.

FIG. 10 is a perspective view showing the connection state of the base panels obtained by implementing the present invention as described in the second embodiment shown in FIGS. 7 and 8.

### BEST MODE FOR CARRYING OUT THE INVENTION

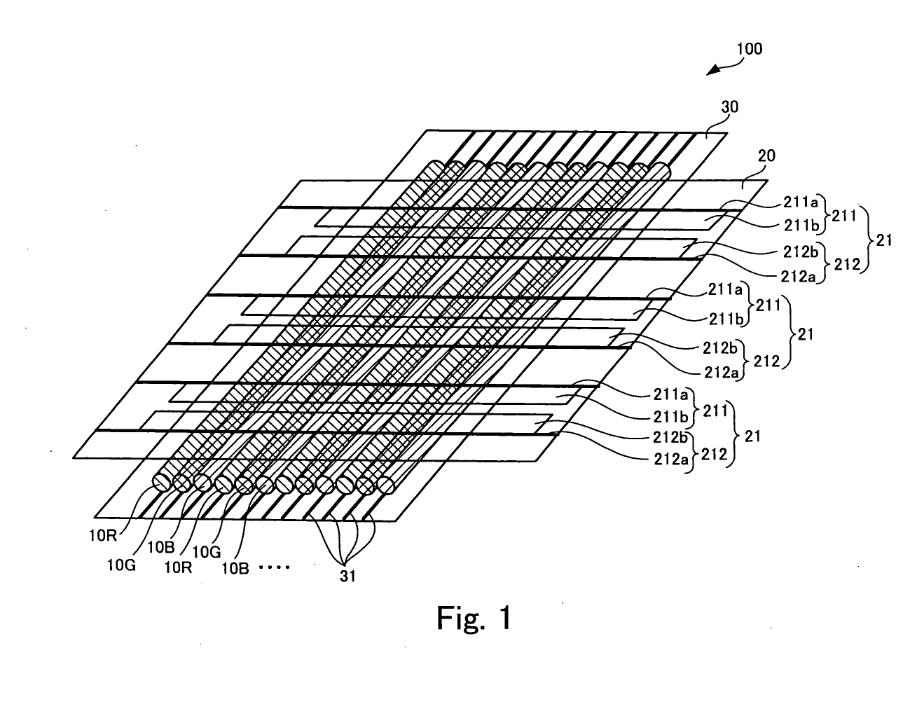

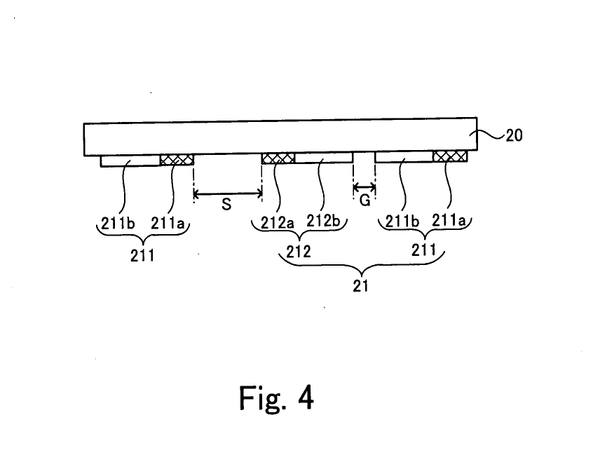

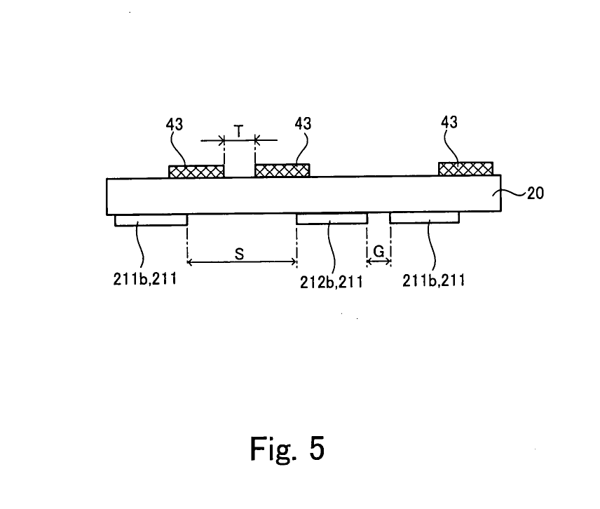

Various embodiments of the present invention will be described below. Note that the various embodiments to be described below are characterized by electrodes and wirings formed on a front supporting substrate. As to the other points, the entire configuration described with reference to FIG. 1 will be applied as it is. Here, only features in the respective embodiments will be shown in the drawings and described. Moreover, in FIGS. 5 to 10, elements corresponding to the elements shown in FIG. 4 are denoted by the same reference numerals as those in FIG. 4, and description thereof may be omitted.

FIG. 5 is a view showing a front supporting substrate 20 and display electrodes 211 and 212 formed on the front supporting substrate 20, in a plasma tube array according to the first embodiment of the present invention.

On the inner surface of the front supporting substrate 20, the display electrodes 211 and 212 made respectively of only transparent electrodes 211b and 212b are formed. On the outer surface of the front supporting substrate 20, wirings 43 instead of bus electrodes 211a and 212a are formed.

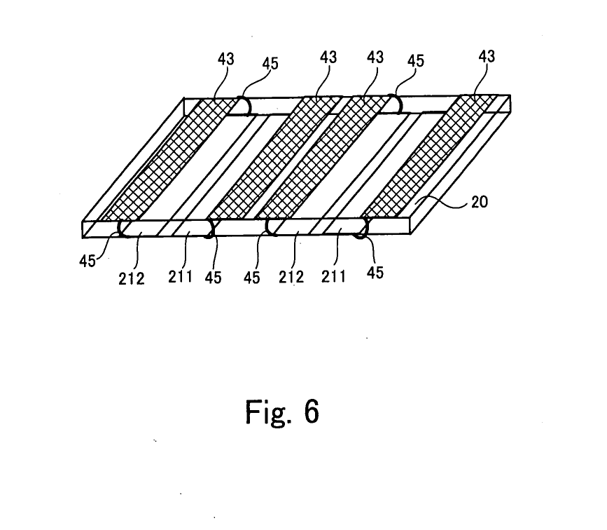

FIG. 6 is a view showing a method of connecting the display electrodes 211 and 212 formed on the inner surface of the front supporting substrate 20 respectively to the wirings 43 formed on the outer surface of the front supporting substrate 20 according to the first embodiment shown in FIG. 5.

Each of the display electrodes 211 and 212 formed on the inner surface of the front supporting substrate 20 and a corresponding one of the wirings 43 formed on the outer surface of the front supporting substrate 20 are connected to each other on both sides of the front supporting substrate 20 with metal wires 45.

The description will be continued with reference to FIG. 5 again.

Each of the wirings 43 is made of a Cr/Cu/Cr metal thin film, and is black with low reflectivity. The wirings 43 are formed respectively at positions facing a reverse slit S with a space T, which is narrower than the reverse slit S, between the wirings 43, so as to cover the reverse slit S. Accordingly, reflectivity of the entire surface of a panel is reduced, and thereby the bright room contrast is improved.

Here, each of the wirings 43 is exposed to air, and has a high dielectric breakdown voltage. For this reason, it is possible to sufficiently avoid discharge even with such a narrow space T. Moreover, each of the wirings 43 can be formed with a sufficient width. For this reason, the reflectivity can be lowered even just by attaching an oxide film, for example, to a surface of the wiring 43.

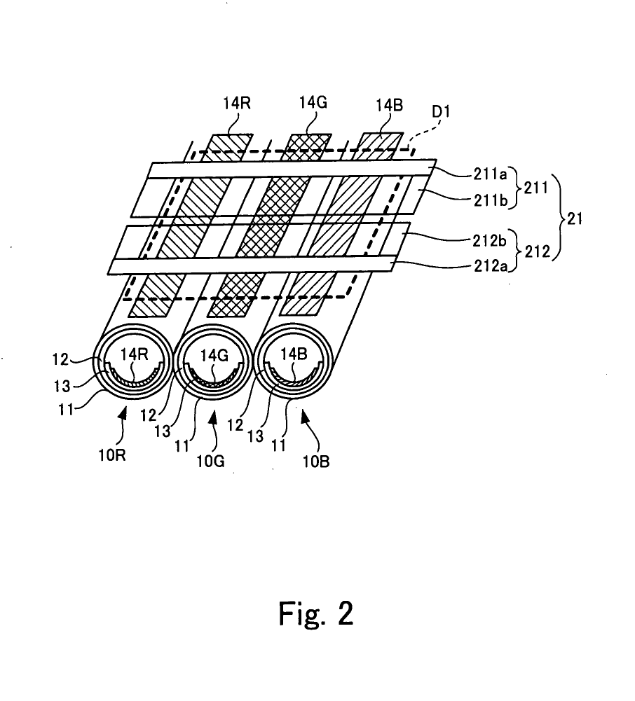

Moreover, in the case of the first embodiment shown in FIG. 5, the display electrodes 211 and 212 are formed respectively of only the transparent electrodes 211b and 212b. For this reason, it is possible to efficiently utilize light emitted from the phosphor layers 14R, 14G and 14B (see FIG. 2) without shielding the light. As a result, bright display can be performed.

Note that each of the display electrodes 211 and 212 may be formed of a metal thin film with a mesh pattern, or the like, having an opening sufficient for transmitting emitted light, instead of the transparent electrodes 212b and 211b.

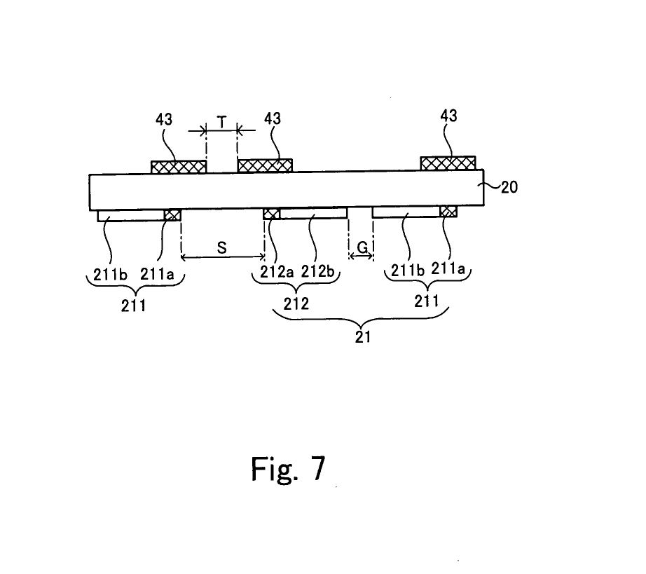

FIG. 7 is a view showing a front supporting substrate 20 and display electrodes 211 and 212 formed on the front supporting substrate 20 in a plasma tube array according to a second embodiment of the present invention. Description will be given of what is different from the first embodiment shown in FIG. 5.

In the case of the first embodiment shown in FIG. 5, the surface electrodes 211 and 212 are formed of only the transparent electrodes 212b and 212b, respectively. However, with only the transparent electrodes, it may be difficult to obtain a sufficiently low resistance value even if the wirings 43 are included. Moreover, there is also a disadvantage that disconnection is likely to occur. Accordingly, in the second embodiment shown in FIG. 7, each of the display electrodes 211 and 212 is formed of a corresponding one of transparent electrodes 211b and 212b and a corresponding one of bus electrodes 211a and 212a made of metal thin films, as in the case of the conventional example shown in FIG. 4. However, in this embodiment, wirings 43 are formed on the outer surface of the front supporting substrate 20, and each of the wirings 43 and a corresponding one of the display electrodes 211 and 212 are connected to each other on both sides of the front supporting substrate 20. Accordingly, the width of each of the bus electrodes 211a and 212a can be made much smaller than that in the conventional example shown in FIG. 4. As a result, use efficiency of the light emitted by the phosphor layers is improved.

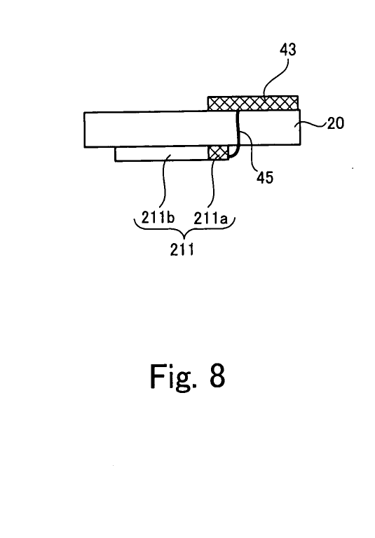

FIG. 8 is a view showing a method of connecting the display electrodes 211 and 212 respectively to the wirings 43 in the second embodiment shown in FIG. 7. Although, FIG. 8 shows only one display electrode 211, the method is common to all the display electrodes 211 and 212.

As shown in FIG. 8, the wiring 43 is connected to the bus electrode 211a made of a metal thin film in the display electrode 211 with a wire 45. This is because, in the case where the wire 45 is connected by soldering, the bus electrode 211a made of a metal thin film can be soldered more firmly than the transparent electrode 211b can.

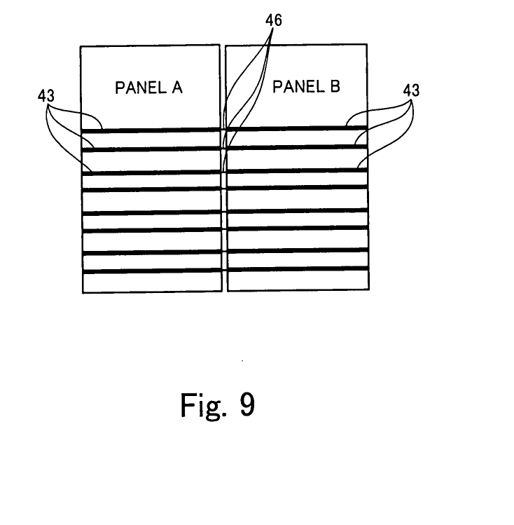

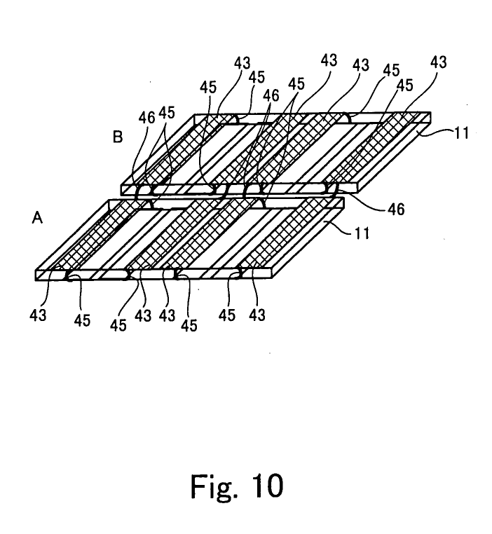

FIGS. 9 and 10 are a plan view and a perspective view, respectively, each showing a state where a number of base panels (here, two panels A and B) are connected. The base panels are obtained by implementing the present invention as described in the second embodiment shown in FIGS. 7 and 8, for example. In addition, FIGS. 9 and 10 show only an overall supporting substrate on the front side of a display device.

On the panels A and B, the wirings 43 are arranged in a direction linearly extending across the two panels. Moreover, the wirings 43 on the respective two panels are connected to each other with wires 46 between the panels adjacent to each other.

When the electrode structure in which the wirings 43 are formed on the outer surface of the glass substrate is adopted in this manner, a supersize display system can be formed by connecting a number of panels as shown in FIGS. 9 and 10. Moreover, by connecting the panels as shown in FIGS. 9 and 10, the panels can be driven by one drive circuit. The following are advantages of driving a number of panels with one drive circuit. First, circuit costs are reduced. Secondly, good continuity of image between panels is realized. To be more specific, even if there are a number of panels, maintenance electrodes are connected to one another, and thus can be regarded as one electrode. Accordingly, there is no variation in brightness due to a difference in display load. For this reason, even if the supersize display system is formed, good continuity of image and good display quality are achieved.

Meanwhile, in the case where a large display system is formed by combining a number of conventional panels, the panels are driven respectively by independent drive circuits. Accordingly, even if one image is displayed by use of the panels, image loads handled by the respective panels are different from one another. For this reason, brightness or gradation expression may become uneven. Specifically, in view of one electrode line, the difference in the image load among the panels changes the amount of voltage drop due to line resistance. Accordingly, effective voltages within discharge cells differ from one another, causing the difference in brightness. Moreover, in view of one panel, since every panel has a different load, an APC point for adjusting power and brightness of the panel is different, causing a difference in the drive frequency. Specifically, either case leads to a result that continuity of line brightness cannot be maintained. In the case where the conventional panels are combined, even if the APC point (the drive frequency) can be synchronized by centralized management of all the panels, the voltage drop amount due to the line resistance cannot be controlled.

As described above, according to the embodiments, a low-resistance display electrode, a low-reflectivity panel and a supersize panel can be realized at low cost.

1. A plasma tube array comprising:
a plurality of arc tubes which are arranged parallel to one another, each arc tube including a phosphor layer inside;
front and back supporting substrates which hold the plurality of arc tubes therebetween;
a plurality of display electrodes which are formed in a direction across the plurality of arc tubes, on a surface of the front supporting substrate, the surface facing the plurality of arc tubes;
a plurality of signal electrodes which are formed in a direction along the plurality of arc tubes in a manner that the plurality of signal electrodes correspond respectively to the arc tubes, on a surface of the back supporting substrate, the surface facing the plurality of arc tubes; and
a plurality of wirings, which are formed in a direction in which the plurality of display electrodes are extended on a display surface of the front supporting substrate, the display surface being opposite to the surface where the plurality of display electrodes are formed, and which are connected respectively to the plurality of display electrodes.

2. A plasma tube array comprising a plurality of unit panels, each unit panel including:
a plurality of arc tubes which are arranged parallel to one another, each arc tube including a phosphor layer inside;
front and back supporting substrates which hold the plurality of arc tubes therebetween;
a plurality of display electrodes which are formed in a direction across the plurality of arc tubes, on a surface of the front supporting substrate, the surface facing the plurality of arc tubes;
a plurality of signal electrodes which are formed in a direction along the plurality of arc tubes so as to correspond respectively to the arc tubes, on a surface of the back supporting substrate, the surface facing the plurality of arc tubes; and
a plurality of wirings, which are formed so as to correspond to the display electrodes on an outer surface of the front substrate, on the reverse side of an inner surface thereof where the display electrode pairs are arranged, which extend parallel to the display electrodes, and which are connected to the corresponding display electrodes, wherein
each of the wirings is arranged in a direction linearly extending across the plurality of unit panels, and
the wirings are connected to each other between the unit panels adjacent to each other.

3. The plasma tube array according to claim 2, wherein at least a part of each of the display electrodes is formed of an electrode made of an optically transparent material.

4. The plasma tube array according to claim 2, wherein at least a part of each of the display electrodes is formed of a mesh electrode made of a metal material.

5. The plasma tube array according to claim 2, wherein each of the display electrodes is connected to a corresponding one of the wirings at both ends of the front substrate by use of metal wires which are each provided across the end face of the front substrate.

6. The plasma tube array according to claim 2, wherein the wirings are formed respectively at positions facing a reverse slit with a gap between the wirings, the gap is narrower than the width of the reverse slit.
